(19) United States
(12) Patent Application Publication
(10) Pub. No.: US 2013/0021822 A1
(43) Pub. Date: Jan. 24, 2013

(54) Optical Waveguide Plate Comprising Phosphorus-Containing Structure Elements

(71) Applicant: Rebekka Wimmer, Langen bei Bregenz (AT)

(72) Inventor: Rebekka Wimmer, Langen bei Bregenz (AT)

(73) Assignee: Zumtobel Lighting GmbH, Dornbirn (AT)

(21) Appl. No.: 13/574,098

(22) PCT Filed: Jan. 17, 2011
(86) PCT No.: PCT/EP2011/005037

§ 371 Date: Aug. 15, 2012

(30) Foreign Application Priority Data
Jan. 20, 2010 (DE) 20 2010 001 155.8

(51) Int. Cl. G02B 6/10; F21V 7/00; F21V 8/00

(52) U.S. Cl. 362/612; 362/611; 362/615; 362/623; 385/129

(57) ABSTRACT

The invention relates to an optical waveguide plate having a first flat side (2), a second flat side (4), which is parallel to the first flat side, and an end face (6). The end face (6) is provided for coupling in light, and the second flat side (4) is provided for coupling out the light coupled in via the end face (6). The first flat side (2) has structure elements (8) that serve for coupling out the light and comprise phosphorus. In this way, the phosphorus can be arranged at such a spatial distance from a corresponding light source (10), serving for coupling in the light via the end face (6), that heating of the phosphorus that possibly has an adverse effect, caused by the operation of the light source (10), can be avoided. Moreover, this makes it possible to provide, at different locations of the first flat side (2), structure elements (8) which differ in their phosphorus composition, such that, in this way, light having different spectral compositions, that is to say different white hues, for example, is coupled out at the different locations of the optical waveguide plate.

The invention relates to an optical waveguide plate having a first flat side and a second flat side parallel thereto and also an end face, wherein the end face is provided to couple in light and the second flat side to couple out the light. The first flat side has structure elements which are used to couple out the light. Furthermore, the invention relates to a lighting arrangement having such an optical waveguide plate and also to a luminaire having such a lighting arrangement.

A corresponding optical waveguide plate is known from a lighting arrangement in which light from an LED (light-emitting diode) that emits blue light is used for coupling-in purposes; the blue light, before being coupled into the optical waveguide plate, is converted into white light by means of a light-influencing element that contains phosphor.

In the case of the known arrangement there is the risk that as a result of heat that develops as a result of the operation of the LED, the phosphor of the light-influencing element will be negatively impaired. Moreover, in the case where the spectral composition of the white light is to be additionally modified before being coupled out of the optical waveguide plate, a separate further light-influencing element is required.

The underlying object of the invention is to specify an optical waveguide plate with which improved coupling-out of white light is possible. Moreover, a corresponding lighting arrangement and also a corresponding luminaire are to be specified.

This object is achieved in accordance with the invention with the subject matter mentioned in the independent claims. Special embodiments of the invention are specified in the dependent claims.

In accordance with the invention an optical waveguide plate is provided that has a first flat side, a second flat side parallel to the first flat side, and an end face, wherein the end face is provided to couple in light, and the second flat side is provided to couple out the light coupled in by way of the end face. The first flat side has structure elements which are used to couple out the light. The structure elements contain phosphor.

In this way, the phosphor can be arranged so that it is so spatially remote from a corresponding light source used to couple in the light by way of the end face that heating of the phosphor, possibly having a negative effect, due to the operation of the light source can be avoided.

Moreover, it is made possible for structure elements that differ in terms of their phosphor composition to be provided at different points of the first flat side so that light of different spectral compositions, that is, for example, of different white hues, is coupled out at the different points of the optical waveguide plate in this way.

The structure elements preferably consist of phosphor. This renders possible a particularly high degree of efficiency with regard to the spectral variation in the light when there is interaction with the structure elements.

Advantageously, with regard to production the structure elements are printed on the first flat side of the optical waveguide, preferably by means of screen-printing methods.

It is likewise advantageous if the first flat side has depressions in which the structure elements are arranged. In this way, the diffuse spreading action of the structure elements can be positively influenced or intensified.

Advantageously, the structure elements are arranged in a non-uniform manner on the first flat side and/or are of differing size. In this way, the distribution of the light that is emitted by the optical waveguide plate by way of the second flat side can be influenced in a targeted manner. For example, in this way relatively uniform radiation can be attained in that with increasing spacing from the corresponding light source the structure elements are formed so as to be denser or with an increasing area.

Advantageously, the structure elements comprise a first structure element and a second structure element, wherein the first structure element has a phosphor of a first kind, and the second structure element has a phosphor of a second kind that differs from the first kind. As a result, a situation can be achieved where a light is emitted from the optical waveguide plate by way of the first structure element that is of a different spectral composition from that emitted by way of the second structure element. In this way, light-emission of the optical waveguide plate can be effected that is different spectrally at different points, over the region of the second flat side.

Advantageously, the structure elements are connected together by way of a carrier element. The carrier element can in particular be a metal plate. This renders possible particularly effective cooling of the structure elements. Moreover, the metal plate can be configured so as to be reflective, so that as a result the degree of efficiency of the optical waveguide plate is increased.

In accordance with a second aspect of the invention, a lighting arrangement is provided that has an optical waveguide plate in accordance with the invention.

The lighting arrangement preferably has, furthermore, a light source for coupling in the light by way of the end face.

The light source is then preferably formed in such a way that it can radiate blue light. By interaction with phosphor, blue light can be converted into white light. In particular, the light source can comprise at least one LED that can radiate blue light.

Furthermore, the lighting arrangement advantageously has a plate-shaped reflector arranged adjacently to the first flat side of the optical waveguide plate. The reflector can in particular be a metal plate; in this way particularly effective cooling of the structure elements is rendered possible.

In accordance with a third aspect of the invention, a luminaire is provided that has a lighting arrangement in accordance with the invention.

The invention is explained in greater detail in the following with the aid of an exemplary embodiment and with reference to the drawings, in which:

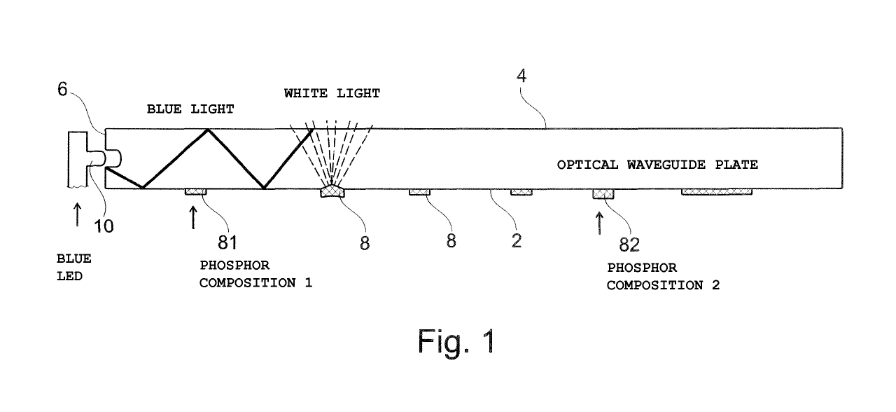

FIG. 1 shows a cross-sectional outline of an exemplary embodiment of a lighting arrangement in accordance with the invention, and

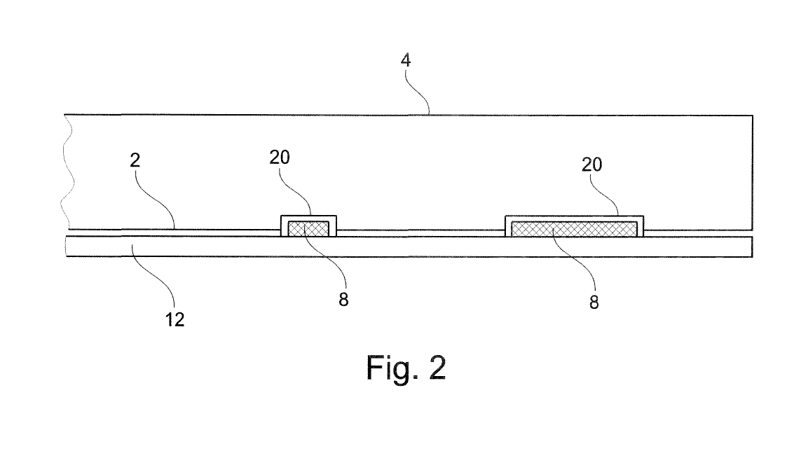

FIG. 2 shows an outline of a variant with regard to the formation of the structure elements on the first flat side of the optical waveguide plate.

FIG. 1 shows a cross-sectional outline of an exemplary embodiment of a lighting arrangement in accordance with the invention that has an optical waveguide plate in accordance with the invention. The optical waveguide plate has a first flat side 2 and a second flat side 4, parallel to the first flat side 2, and also an end face 6. The end face 6 is provided, in this connection, to couple in light. For this, the lighting arrangement can have in particular a light source 10 which is formed in such a way that it can radiate blue light. For example, the light source 10 can be one LED or a plurality of LEDs arranged in a row along the end face 6.

The second flat side 4 is provided in order to couple out the light coupled into the optical waveguide plate by way of the light source 10. For this, the first flat side 2 has structure elements 8. The structure elements 8 can be formed in particular in such a way for this that they spread the light coupled in by way of the end face 6 in such a diffuse manner that the light thus spread as it proceeds further at least in part leaves the optical waveguide plate by way of the second flat side 4.

The structure elements 8 contain phosphor or consist of phosphor. As a result of interaction with phosphor, blue light can be converted into white light. In this way, it is made possible for white light to be emitted from the optical waveguide plate or from the lighting arrangement by way of the second flat side 4.

In the configuration in accordance with the invention the phosphor of the structure elements 8 can be arranged so far away from the light source 10 that heating, caused by the operation of the light source 10, cannot impair the phosphor in a negative way.

The structure elements 8 thus perform a dual function in accordance with the invention. They are used not only to couple out the light from the optical waveguide plate, but also give rise to a spectral variation in the light.

The structure elements 8 can be formed, for example, by printing phosphor onto the first flat side 2 of the optical waveguide plate. A screen-printing method is suitable for this, for example.

As shown in the outline of FIG. 2, alternatively or in addition it can also be provided that the first flat side 2 of the optical waveguide plate has recesses or depressions 20, in which the structure elements 8 are arranged. The depressions 20 can then be formed in such a way that they further promote the coupling-out of the light which has been coupled in by way of the end face 6. The phosphor-containing structure elements 8 can then be arranged within the depressions 20—for example with a slight interspace.

The structure elements 8 can be connected together, furthermore, by way of a carrier element. The carrier element can be, for example, a metal plate 12. With the metal plate 12 it is possible to achieve a situation where the surface of the metal plate 12 pointing to the first flat side 2 of the optical waveguide plate has a reflective effect so that the degree of efficiency of the lighting arrangement can be increased overall as a result. Moreover, as a result of corresponding dimensioning, it metal plate 12 acts as a heat sink for the structure elements 8.

A corresponding plate-shaped reflector is also possible in an advantageous way in the case of the embodiment shown in FIG. 1 with regard to improving the degree of efficiency. The reflector can then be arranged in a corresponding manner adjacently to the first flat side 2 of the optical waveguide plate. This reflector can also be a metal plate. If the reflector is then arranged in such a way that it contacts the structure elements 8, in this case it can also serve as a heat sink for the structure elements 8.

A corresponding reflector is not, however, absolutely necessary. In particular, it can be provided that light-emission from the optical waveguide plate can also be effected by way of the first flat side 2. In this case, accordingly advantageously no such reflector is provided. For example, a luminaire having a lighting arrangement in accordance with the invention can be provided in which provision is made for light-emission by way of the second flat side 4 in order to generate direct lighting and for further light-emission by way of the first flat side 2 in order to generate indirect lighting.

As shown in the diagram in FIG. 1, it can be provided that the structure elements 8 are arranged in a non-uniform manner on the first flat side 2 and/or that they are of differing size. For example, the degree of printing can thus be dependent on location. In this way, it is possible to influence the distribution of the light that is emitted by way of the second flat side 4 of the optical waveguide plate. In particular, in order to achieve light-emission that is as uniform as possible it can be provided that the structure elements 8 are arranged so that they become denser with increasing spacing from the light source 10 and/or in each case cover an increasingly larger area of the first flat side 2.

As indicated, furthermore, in FIG. 1, it can be provided that the structure elements 8 comprise a first structure element 81 and a second structure element 82, wherein the first structure element 81 has a phosphor of a first kind, and the second structure element 82 has a phosphor of a second kind that differs from the first kind. For example, the first structure element 81 can have a first phosphor composition, and the second structure element 82 can have a second phosphor composition. Different phosphor compositions generally generate differing white light in the event of interaction with blue light. Thus a situation can be achieved where light is emitted from the optical waveguide plate that has different white hues at different points.

Advantageously, a lighting arrangement having an optical waveguide plate in accordance with the invention is provided as part of a luminaire. In this connection, in particular the second flat side 4 of the optical waveguide plate can be used as a radiating surface of the luminaire.

1. An optical waveguide plate having
a first flat side (2),
a second flat side (4) that is parallel to the first flat side (2), and
an end face (6),
wherein the end face (6) is provided to couple in light, and the second flat side (4) is provided to couple out the light that is coupled in by way of the end face (6), and wherein the first flat side (2) has structure elements (8) that are used to couple out the light, characterised in that the structure elements (8) contain phosphor.

2. An optical waveguide plate according to claim 1, in which the structure elements (8) consist of phosphor.

3. An optical waveguide plate according to claim 1, in which the structure elements (8) are printed on the first flat side (2) of the optical waveguide plate, preferably by means of screen-printing methods.

4. An optical waveguide plate according claim 1, in which the first flat side (2) has depressions in which the structure elements (8) are arranged.

5. An optical waveguide plate according claim 1, in which the structure elements (8) are arranged in a non-uniform manner on the first flat side (2) and/or are of differing size.

6. An optical waveguide plate according to claim 1, in which the structure elements (8) comprise a first structure element (81) and a second structure element (82), wherein the first structure element (81) has a phosphor of a first kind, and the second structure element (82) has a phosphor of a second kind that differs from the first kind.

7. An optical waveguide plate according to claim 1, in which the structure elements (8) are connected together by way of a carrier element.

8. An optical waveguide plate according to claim 7, in which the carrier element is a metal plate (12) that is preferably reflective.

9. A lighting arrangement, having
an optical waveguide plate according to claim 1.

10. A lighting arrangement according to claim 9, further comprising
a light source (10) for coupling in the light by way of the end face (6).

11. A lighting arrangement according to claim 10, in which the light source (10) can radiate blue light, wherein the light source (10) preferably comprises at least one LED.

12. A lighting arrangement according to claim 9, further comprising
a plate-shaped reflector which is arranged adjacently to the first flat side (2) of the optical waveguide plate.

13. A lighting arrangement according to claim 12, in which the reflector is a metal plate.

14. A luminaire having
a lighting arrangement according to claim 9.
